(19) United States
(12) Patent Application Publication
(10) Pub. No.: US 2008/0155962 A1
(43) Pub. Date: Jul. 3, 2008

(54) Pressure or temperature sensor control of a variable position exhaust throttle valve

(75) Inventors: Ben Williams, Chatham (CA); Robert D. Jefford, Chatham (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Canada Inc., Chatham (CA)

(21) Appl. No.: 11/984,919

(22) Filed: Nov. 26, 2007

Related U.S. Application Data
(60) Provisional application No. 60/868,802, filed on Dec. 6, 2006.

(51) Int. Cl. F02D 9/08; F02D 9/04; F16K 31/00

(52) U.S. Cl. 60/273; 60/324

(57) ABSTRACT

An exhaust throttling valve (ETV) system (10) is provided for a vehicle. The system includes an ETV (12) having a housing (14), a valve member (16) movable with respect to the housing between at least one state and another state within an exhaust gas flow path, and an actuator (18) for moving the valve member. Sensor structure (20) in the form of a pressure sensor or a temperature sensor is mounted upstream or downstream of the valve member in the exhaust gas flow path. The sensor structure is constructed and arranged to determine an operating condition of the valve member such as position of the valve member and/or whether the valve member has moved from one state to the other state.

This application claims the benefit of the earlier filing date of U.S. Provisional Application No. 60/868,802, filed on Dec. 6, 2006, which is hereby incorporated by reference into this specification.

### FIELD OF THE INVENTION

This invention relates to detecting and controlling position of a valve and, more particularly, to a temperature or pressure sensor to determine valve position and/or condition in flow/pressure regulation of high temperature flow applications in vehicles.

### BACKGROUND OF THE INVENTION

An Exhaust Throttling Valve (ETV) is used on engines using the Multi Displacement System (MDS). Engines utilizing MDS will disable combustion within several cylinders of the engine during steady state conditions to improve fuel economy. In a drive to utilize MDS more often and capitalize on the fuel economy benefits of this system, engine/vehicle manufactures have investigated utilizing MDS under idle conditions.

MDS at idle, however, creates audible noise issues since the conventional exhaust systems are not tuned for this condition. Solutions, such as a secondary exhaust path solve this issue, but are costly. The ETV offers a solution to the convention dual exhaust path solutions by activating during MDS events to increase exhaust backpressure, simulating back-pressure conditions experienced when MDS is inactive.

Currently, an actuator position sensor is used to indicate valve position of the conventional EVT of a vehicle. This sensing method only indicates the actuator position and relies on a functioning linkage between the actuator and the valve, with the valve being in good working order. The position of the valve, the presence of a seal, the failure of a linkage, or damage to the valve cannot be accurately detected by the actuator position sensor. The actuator position sensor may signal the correct valve position when in fact the valve is significantly damaged and/or not performing as expected.

There is a need to determine position and/or condition of a valve in flow/pressure regulation of high temperature flow applications.

### SUMMARY OF THE INVENTION

An object of the invention is to fulfill the need referred to above. In accordance with the principles of the present invention, this objective is obtained by providing An exhaust throttling valve (ETV) system is provided for a vehicle. The system includes an ETV having a housing, a valve member movable with respect to the housing between at least one state and another state within an exhaust gas flow path, and an actuator for moving the valve member. Sensor structure in the form of a pressure sensor or a temperature sensor is mounted upstream or downstream of the valve member in the exhaust gas flow path. The sensor structure is constructed and arranged to determine an operating condition of the valve member such as position of the valve member and/or whether the valve member has moved from the one state to the other state.

In accordance with another aspect of the invention, an exhaust throttling valve (ETV) system for a vehicle includes an ETV having a housing, a valve member movable with respect to the housing between at least one state and another state within an exhaust gas flow path, and an actuator for moving the valve member. Means, mounted upstream or downstream of the valve member in the exhaust gas flow path, is provided for determining an operating condition of the valve member.

In accordance with yet another aspect of the invention, a method determines an operating condition of an exhaust throttling valve (ETV) for a vehicle. The method provides an ETV having a housing, a valve member movable with respect to the housing between at least one state and another state within an exhaust gas flow path, and an actuator for moving the valve member. Pressure or temperature is sensed within the gas flow path upstream or downstream of the valve member. Based on the sensing, an operating condition of the valve member is determined.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 perspective view of an exhaust throttling valve (ETV) system in accordance with an embodiment of the present invention.

### DETAILED DESCRIPTION OF THE EXEMPLARY EMBODIMENTS

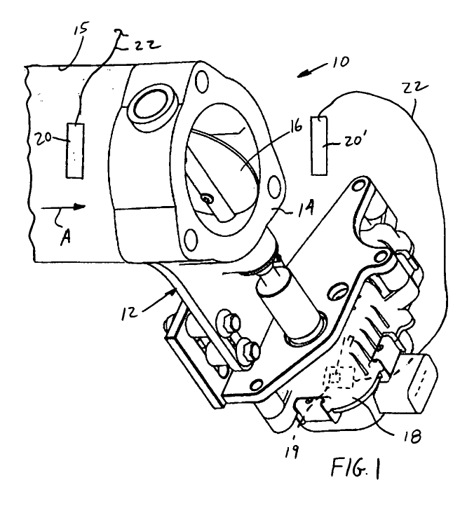

With reference to FIG. 1, a ETV system is shown, generally indicated at 10, in accordance with the principles of an embodiment of the invention. The system 10 includes a conventional ETV, generally indicated at 12, having a housing 14 for mounting to an exhaust gas flow path 15, a valve member 16 movable with respect to the housing between at least first and second states with the exhaust gas flow path 15, and an actuator 18 for moving the valve member 16. The exhaust gas flow path 15 is shown only upstream of the valve member 16 in FIG. 1 for clarity of illustration. However, it can be appreciated that the exhaust gas flow path 15 extends downstream of the valve member 16 as well. The valve member 16 is preferably moveable to various positions within the gas flow path. The system includes sensor structure 20. Since pressure and temperature are directly influenced by the position of the valve member 16, the sensor structure 20, in the form of a temperature or pressure sensor, provides direct information about the state of the valve member 16. A temperature or pressure sensor 20 is placed upstream of the valve member 16 in the exhaust flow path 15. Flow direction is shown by the arrow A in FIG. 1. As the valve member 16 actuates from an open state to a closed state, the valve member 16 will restrict flow in the flow path 15, causing an increase in temperature and pressure therein. As the valve member 16 actuates from the closed state to the open state, flow restrictions will be reduced, causing a decrease in temperature and pressure in the flow path 15.

A valve operating condition such as position and/or state of the valve member 16 can be determined through the comparison (e.g., by a controller 19 of the actuator 18) of expected temperature/pressure values to measured temperature/pressure values (obtained by sensor structure 20), or through the expected change in temperature/pressure. The expected temperature/pressure values are preferably provided in a look-up table 17 associated with the controller 19. The controller 19 can be part of or separate from the actuator 18.

Instead of providing the sensor structure upstream of the valve member 16, the sensor structure 20′ can be positioned downstream of the valve member 16 within the exhaust flow path. Temperature and pressure changes downstream will be the opposite of the upstream temperature and pressure changes.

The advantage of using a pressure or temperature sensor 20 or 20′ is that the variable being measured is directly affected by the state of the valve member 16. The conventional actuator position sensor indicates the state of the actuator 18, but can only indicate a possible state of the valve member 16. The actuator 18 may have moved, but the coupling to the valve member 16 could be broken. When using the sensor structure 20 or 20′ however, a lack of change in temperature/pressure when the valve member 16 is instructed to change states is a direct indicator of the performance of the valve member 16.

This sensor structure 20 or 20′ can also be used as part of a closed loop system to control flow and backpressure in real time. For example, sensor 20 or 20′ can be electrically connected via wire 22 with the controller 19 and integrated circuitry within the controller 19 or actuator 18 can monitor pressure or temperature and adjust the position of the valve member 16 to control pressure or temperature to a desired level. Conventional systems use an open loop control of the valve member through the actuator position sensor only.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An exhaust throttling valve (ETV) system for a vehicle comprising:
an ETV having a housing, a valve member movable with respect to the housing between at least one state and another state within an exhaust gas flow path, and an actuator for moving the valve member, and
sensor structure in the form of at least one of a pressure sensor or a temperature sensor mounted at least one of upstream or downstream of the valve member in the exhaust gas flow path, the sensor structure being constructed and arranged to determine an operating condition of the valve member.

2. The ETV system of claim 1, wherein the sensor structure is a temperature sensor mounted upstream of the valve member.

3. The ETV system of claim 1, wherein the sensor structure is a pressure sensor mounted upstream of the valve member.

4. The ETV system of claim 1, wherein the sensor structure is a temperature sensor mounted downstream of the valve member.

5. The ETV system of claim 1, wherein the sensor structure is a pressure sensor mounted downstream of the valve member.

6. The ETV system of claim 1, wherein the determined operating condition is a position of the valve member.

7. The ETV system of claim 1, wherein the determined operating condition is whether the valve member has moved from the one state to the other state.

8. The ETV system of claim 1, wherein the sensor structure is electrically connected with a controller associated with the actuator.

9. The ETV system of claim 8, wherein a look-up table is associated with the controller, the look-up table containing expected values of one of temperature or pressure, the controller being constructed and arranged to compare the expected values to values of pressure or temperature measured by the sensor structure.

10. An exhaust throttling valve (ETV) system for a vehicle comprising:
an ETV having a housing, a valve member movable with respect to the housing between at least one state and another state within an exhaust gas flow path, and an actuator for moving the valve member, and
means, mounted at least one of upstream or downstream of the valve member in the exhaust gas flow path, for determining an operating condition of the valve member.

11. The ETV system of claim 10, wherein the means for determining comprises at least one of a pressure sensor or a temperature sensor.

12. The ETV system of claim 10, wherein the means for determining is a temperature sensor mounted upstream of the valve member.

13. The ETV system of claim 10, wherein the means for determining is a pressure sensor mounted upstream of the valve member.

14. The ETV system of claim 11, wherein the operating condition is whether the valve member has moved from the one state to the other state.

15. The ETV system of claim 11, wherein the operating condition is a position of the valve member.

16. The ETV system of claim 11, wherein the sensor is electrically connected with a controller associated with the actuator.

17. The ETV system of claim 16, wherein a look-up table is associated with the controller, the look-up table containing expected values of one of temperature or pressure, the controller being constructed and arranged to compare the expected values to values of pressure or temperature measured by the sensor structure.

18. A method of determining an operating condition of an exhaust throttling valve (ETV) for a vehicle, the method comprising:
providing an ETV having a housing, a valve member movable with respect to the housing between at least one state and another state within an exhaust gas flow path, and an actuator for moving the valve member, and
sensing one of pressure or temperature within the exhaust gas flow path at one of upstream or downstream of the valve member, and
based on the sensing, determining an operating condition of the valve member.

19. The method of claim 18, wherein the determining step includes determining whether the valve member has moved from the one state to the other state.

20. The method of claim 18, wherein the determining step includes determining a position of the valve member.
